(19) United States
(12) Patent Application Publication
(10) Pub. No.: US 2008/0244660 A1
(43) Pub. Date: Oct. 2, 2008

(54) VIRTUAL SET-TOP BOX TUNER IN CONTENT DISTRIBUTION SYSTEM

(75) Inventors: JOSEPH F. WODKA, HOFFMAN ESTATES, IL (US); TZVETAN T. HOROZOV, HOFFMAN ESTATES, IL (US); FRANCIS P. JATICO, CHICAGO, IL (US); NITYA NARASIMHAN, LAKE ZURICH, IL (US); DANIEL F. STEWART, HOFFMAN ESTATES, IL (US); VENUGOPAL VASUDEVAN, PALATINE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/691,267

(22) Filed: Mar. 26, 2007

(51) Int. Cl. H04N 5/445; H04N 7/173

(52) U.S. Cl. 725/58; 725/133

(57) ABSTRACT

A method for scheduling the reception of content in a content receiver, for example, in an STB/DVR, includes scheduling (210) the reception of selected content by a tuner resource of the STB/DVR at a particular time. The scheduling may be performed at the STB/DVR, or alternatively at a remote device, for example, at a cellular telephone using an EPG. A virtual tuner is provided (230) to the STB/DVR in the event that the tuner resource of the STB/DVR is not available to receive the selected content when scheduled. In one implementation, usage of the virtual tuner is conditioned on consent to viewing additional non-selected content.

The disclosure relates generally to content distribution, and more specifically to providing a virtual tuner to a content receiver entity, for example, to a set-top box (STB) subscriber in a content distribution system upon satisfaction of a specified condition.

### BACKGROUND

Content distribution systems including cable and satellite based systems are known generally. Cable, satellite and other content providers often employ set-top boxes (STBs) having a tunable receiver for receiving selected content for consumption by the consumer, for example, for viewing on a widescreen monitor. In these systems, content is typically broadcast to multiple users simultaneously and in some systems content may also be provided to individual subscribers on an “on-demand” basis in response to a selection or request by the user browsing an interactive Electronic Program Guide (EPG).

Digital video recorders (DVRs) that record media or content for later consumption are also known. Many content providers, for example, cable service operators, provide service subscribers with an STB having integrated DVR capabilities. These integrated devices are capable of recording scheduled content distributed by the content providers for viewing at a later time. The DVR is typically programmed or scheduled to record programming selected from an EPG. Some DVRs may even be controlled remotely using application run on a cell phone or other remote communication device. The number of tuners available in an STB or DVR for receiving and/or recording digital content however is typically limited. For example, an STB typically has only a single tuner. Thus there are a limited number of channels (or content) that a consumer may access for concurrent viewing or recording at any particular time.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates content distribution network architecture.

FIG. 2 is a process for providing a virtual tuner to a client entity.

FIG. 3 is a process for scheduling the reception of programming at a client entity.

FIG. 4 is a process for scheduling a STB from a remote device.

FIG. 5 is another process for providing a virtual tuner to a client entity.

### DETAILED DESCRIPTION

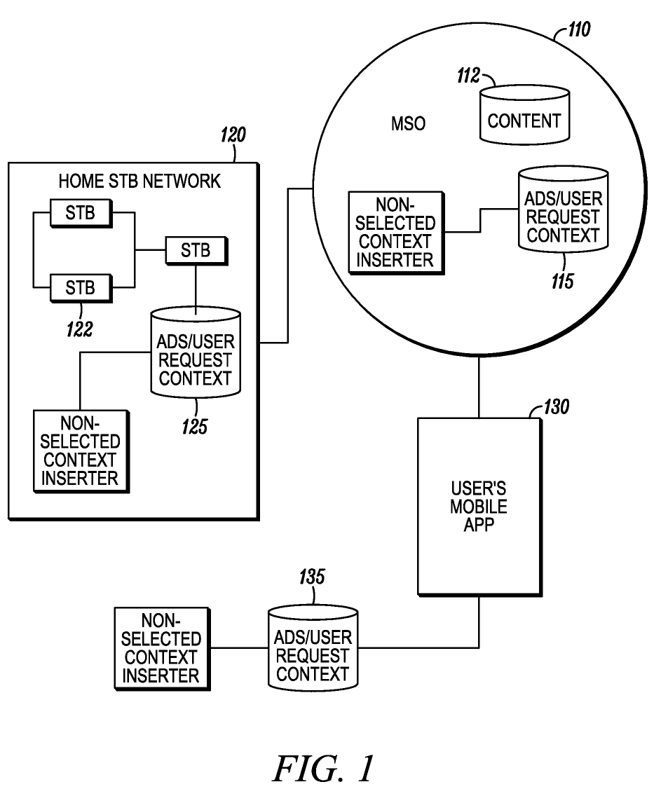

In FIG. 1, content distribution architecture 100 includes a content provider 110 in the exemplary form of a Multiple System Operator (MSO), for example, a cable or satellite communication services provider. More generally, the content distribution provider may be an entity other than an MSO. Such entities include but are not limited to wireless communication services providers, for example, cellular and WIMAX communication services providers, and other content providers. The content provider includes network infrastructure and a wired and/or wireless distribution system capable of distributing content to client entities, for example, to content subscribers, as discussed further below. While exemplary content providers and content distribution system are disclosed, the disclosure is not intended to be limited by any particular content provider type or any particular content distribution architecture.

In FIG. 1, the content provider 110 accesses content from one or more content repositories 112, which may be in the form of servers that constitute content distribution infrastructure or that are communicably coupled thereto. In some embodiments, content or media is licensed from a third party, like a movie studio, and thus the content provider may access content from servers or other repositories owned or managed by third parties. The content provider may provide content pursuant to a broadcast schedule and/or provide the content may be provided on an “on-demand” basis. The content may generally take any form including but not limited to audio, video and other forms of data and/or multimedia, among other content forms. The disclosure is not intended to be limited by a particular source of content or the particular content type or format.

FIG. 1 also illustrates a network 120 of content receivers or entities communicably coupled to the content distribution network. Generally, multiple content receivers are communicably coupled to the content distribution network, either wirelessly or by a wire-line, for example, a cable. The relationship between the content provider and content receiver may be a service provider/subscriber relation. For example, each network 120 may be a residential or business network subscriber account. Each content receiver generally includes a tuner resource having one or more tuners, wherein each tuner is capable of receiving content on a corresponding channel from the content provider. In one embodiment, the content receiver is a set-top box (STB) and/or a digital video recorder (DVR), wherein the devices are integrated or discrete. Exemplary integrated STB/DVR devices are available from MOTOROLA, among others.

FIG. 1 also illustrates a remote device 130 communicably coupled to the content receiver 122 wherein the remote device is capable of controlling the content receiver via an intermediate network. The content receiver may be controlled, for example, by programming or scheduling the recording of content at the content receiver. The remote device 130 is distinguished from a remote control that controls the client device 122 over a short range wireless link, for example, an infrared or Bluetooth link. In one implementation, the remote device is a cellular subscriber device, for example, a GSM/UMTS or CDMA or some other protocol compliant mobile handset, running an application enabling the handset to schedule and program the recording of content on a STB/DVR subscriber device. In another implementation, the STB/DVR is controlled remotely from a computer or some other terminal connected to a network like the Internet.

FIG. 1 also illustrates user context stores 115, 125 and 135 used to capture and store the user's context information and to generate the appropriate non-selected content, for example, promotional media. The context store captures information about content the user has selected and based on this context configures the non-selected content to be used in future user's requests. According to one aspect of the disclosure, context store 115 is the primary store which includes the content provider business and computation rules for determining the appropriate non-selected content to offer based to a specific user. Content stores 125 and 135 are local implementations that capture the context and forward it to the main context store 115. Further, these local stores act as a cache for the non-selected content for the appropriate device and can be used to access the non-selected content directly at each device 122 and 130 instead of accessing the non-selected content directly from the content provider network 110. As the context is exchanged with the primary context store, similarly the cached non-selected content can be exchanged between the primary and local cache context stores.

It is well known to those having ordinary skill in the art how to schedule the programming of a DVR using a cellular telephone connected to a wireless communications network and/or using a computer connected to the Internet. Such services are currently available from communication service providers like VERIZON.

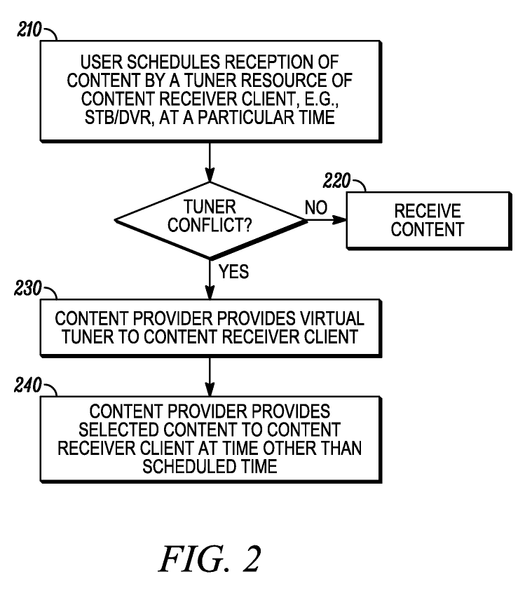

According to one aspect of the disclosure, at 210 of FIG. 2, a user schedules reception of selected content by a tuner resource of a content receiver, for example, an STB/DVR. The scheduling could be for immediate viewing or recording of the content, or the tuner could be scheduled to record the selected content at a future time. In one embodiment, the scheduling is performed by a user at an interactive user interface of the STB/DVR, for example, using a remote control with a direct short-range wireless link to the STB/DVR. The selected content may be accessed using an Electronic Program Guide (EPG) displayed on the STB/DVR, on a short-range remote control device associated therewith or on a television monitor coupled thereto. In another embodiment, the scheduling of the STB/DVR is performed from a remote device, for example, from a cellular telephone or from a remote computing device that that communicates with the STB/DVR via an intermediate network, for example, over a cellular communication network or over the Internet, as discussed above in connection with FIG. 1. The selected content may be access using an Electronic Program Guide (EPG) displayed on the remote device.

In FIG. 2, at 220, if there is no conflict, the client device receives the selected content for viewing or recording at the scheduled time. A conflict may result if the one or more tuner resources are dedicated to receiving some other content at the scheduled time period. For example, if there is only one tuner available, it would not be possible to record content received on one channel while simultaneously receiving some other content on another channel. At 230, the content provider offers a virtual tuner to the client in the event that there is a tuner conflict at the scheduled time.

In one implementation, the content provider provides the virtual tuner by recording the selected content at the scheduled time. For example, the content provider may record content broadcast at the scheduled time. At 240, the content provider provides the recorded content to the content receiver client at a time other than the scheduled time. In some implementations, the content provider stores the recorded content until it is requested by the client. For example, the content provider may provide the selected content “on demand”. Alternatively, after recording, the content provider may download the recorded content for storage on the client device, for example, when the tuner is available. In other implementations, the content provider provides the virtual tuner by retrieving the selected content without actually recording the content. Such a circumstance may arise where the content provider has on-demand access to the selected content from a database or other content repository. In this latter implementation, providing a virtual tuner means retrieving the selected content on behalf of the client.

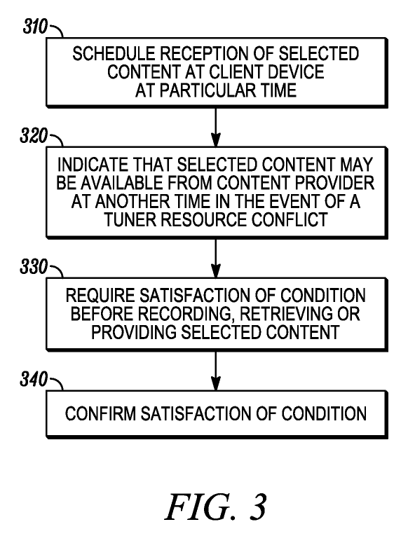

FIG. 3 is a process for scheduling the reception of content in a content receiver having a tuner resource, for example, in an STB/DVR. The scheduling of content reception may, in some embodiments, also include the recording of the received content. The process may be controlled or executed at the content receiver or from a remote device, for example, the device 130 in FIG. 1. In FIG. 3, at 310, the reception of selected content by a tuner resource of the STB/DVR is scheduled at a particular time. The scheduling may be performed directly at a user interface of the client device or from a remote device as discussed above. At 320, in the event that the STB/DVR tuner resource is not available to receive the selected content when scheduled, an indication is provided that the selected content may be available from a content server at another time. In one embodiment, the person performing the scheduling is notified that the content provider may provide a virtual server, for example, record or retrieve the selected content, in the event that the tuner resource is not available to receive the selected content when scheduled. In one embodiment, the notification or indication is presented as a selectable option or offer that requires further input, for example, in the form of an option selection, by the user at the user interface of the device from which the scheduling is performed.

In embodiments where scheduling occurs at the client device, this indication is provided at a user interface of the client device, for example, at a television monitor coupled to the STB/DVR or at a user interface of the client device or a short range remote control device thereof. In embodiments where scheduling occurs at a remote device that communicates with the STB/DVR over an intermediate network, this indication is provided at a user interface of the remote device, for example, on a display of a cellular telephone or on the monitor of a computer connected to the Internet.

In embodiments, where a selection is required of the user to obtain the selected content from the content provider at another time, the user must communicate the acceptance. In some embodiments, at 330, the content provider may require that the user satisfy a condition in order to obtain the selected content from the content provider at the alternative time. Exemplary conditions are discussed further below. At 340, the content provider confirms that the condition has been satisfied before recording, retrieving or providing the selected content. The condition may be satisfied at either the client device, for example the STB/DVR, or at the remote device at which the scheduling occurred. In some implementations, the content provider verifies that the condition has been satisfied before providing the virtual tuner. The particular form of verification depends upon the particular condition imposed.

In one implementation, the content provider requires that the user view non-selected content or content selected by the operator as a condition of obtaining the selected content from the operator at the other time. Thus in some embodiments, the STB/DVR or the remote device from which scheduling was performed receives non-selected content from the content server before the selected content is recorded, or retrieved or made available. The non-selected content could be in the form of promotional content, advertising, or a survey participation requirement. In some embodiments, the promotional content is presented to either the STB/DVR and/or the remote device for viewing before the selected content is recorded, retrieved or delivered to the client device. For example, the content provider may require that the user performing the scheduling view the promotions at the device where scheduling is performed. In other embodiments, the promotional content is delivered to the STB/DVR with the selected content. For example, content provider may require that the promotional information be viewed before, during and/or after the selected content is consumed at the STB/DVR, for example, before viewing on a monitor coupled to the STB/DVR.

In another implementation, the content provider may require authorization to charge a subscriber account before providing the selected content when there is a tuner conflict. Thus the imposed condition may be a requirement for payment. The options to view promotional content or provide authorization to debit a subscriber account, among other options, may be presented and selected at an interactive user interface of the STB/DVR or the remote device from which scheduling was performed. In embodiments where non-selected content is view, the confirmation at may be to indicate that the non-selected content was presented for viewing by a user, either at the client device or at the remote device from which scheduling was performed. Various mechanisms may be used to verify that content was viewed.

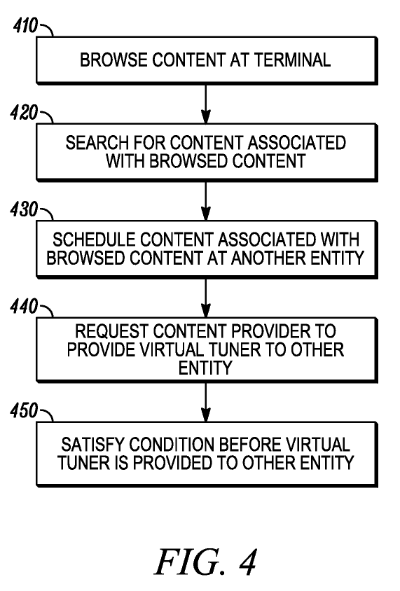

According to another aspect of the disclosure, in FIG. 4 at 410, content is browsed at a terminal that communicates over a communications network. For example, the browsing terminal may be the remote device 130 in FIG. 1, which may be embodied as a mobile device communicating over a wireless communication network or a computer communicating over a network like the Internet. The browsed content may be content that is received over a communications network, for example, the Internet. Alternatively, the browsed content may be content that is stored locally on the terminal. The content could be news, sports, entertainment, promotional, information in a directory or other listing, for example, a scheduled listing in an Electronic Program Guide (EPG), among other types of content.

In FIG. 4, at 420, a search is performed for content associated with the browsed content. The search may be performed by an application running on the browsing terminal wherein the application searches for information related to the browsed content. The search may also be performed in conjunction with other entities located remotely from the terminal. For example, the application may prompt a remote server or other entity to search for remote databases or information repositories for content related to the browsed content. In one embodiment, one or more Electronic Program Guides (EPGs) are searched for information related to the browsed content.

In FIG. 4, at 430, the terminal schedules content associated with the browsed content at a content receiver other than the terminal. In one embodiment, the content receiver is an STB or a DVR, or an integrated STB/DVR. The content scheduling includes scheduling the reception of content by a tuner resource of the other entity. The scheduling of the reception of content may, in some embodiments, also include the recording of the received content, as discussed above.

In FIG. 4, at 440, a content provider is requested to provide a virtual tuner to the content receiver entity in the event that there is a scheduling conflict at the content receiver entity. Scheduling conflicts are discussed above. In one implementation, the content provider records the selected content at the scheduled time. In other implementations, the content provider retrieves the selected content without actually recording the content. In this latter implementation, providing a virtual tuner encompasses retrieving the selected content on behalf of the client. The content provider may store the recorded content until it is requested by the client. Alternatively, after recording, the content provider may download the recorded content for storage on the client device.

In FIG. 4, at 450, in some embodiments, a condition must be satisfied by the terminal before the virtual tuner is provided to the content receiver entity. An indication that the condition has been satisfied may also be required. In one implementation, promotional content must be viewed at the terminal before the virtual tuner is provided. In another embodiment, the promotional content must be viewed at the other entity, for example, before the virtual tuner is provided or before and/or after receiving or viewing the content at the other entity. In another implementation, the condition is the exchange of remuneration for providing the virtual tuner. These and related aspects of the disclosure are discussed hereinabove.

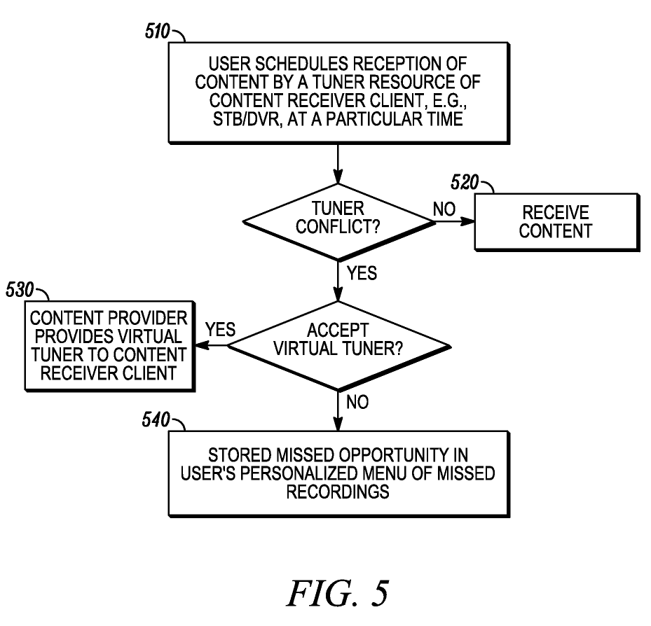

According to another aspect of the disclosure, in FIG. 5 at 510, a user schedules reception of selected content as described above in connection with FIG. 2. In FIG. 5, at 520, if there is no conflict, the client device receives the selected content for viewing or recording at the scheduled time. Further when a tuner conflict arises and the user accepts the condition required for a virtual tuner at 530, the procedure instantiates as described above in FIG. 2 at 230. In FIG. 5, at 540, the user does not accept the conditional access requirement for receiving non-selected content in exchange for recording the selected content. In one implementation, when the user does not accept the conditions to record their selected content, the selected content information is stored in the user's personalized menu of Missed Recordings. The missed recording information is stored at the content receiver, for example, at 122 and at the remote device 130 in FIG. 1.

When a user views their Missed Recordings menu and selects an item there, the content provider offers a video-on-demand capability for the missed content if available and displays non-selected content. Further in one implementation, the selected content information that has been recorded is stored in a personalized Recordings Menu on the user's remote device and non-selected content is displayed whenever the user accesses an item within this menu.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method for scheduling the reception of content at a content receiver communicably coupled to a content distribution system operated by a content provider, the method comprising:
selecting content;
scheduling reception of the selected content by a tuner resource of the content receiver at a particular time;
the content provider providing a virtual tuner to the content receiver in the event that the tuner resource of content receiver is not available at the particular time.

2. The method of claim 1, selecting content from an electronic program guide at the content receiver.

3. The method of claim 1, selecting content from an electronic program guide at a remote device communicably coupled to the content receiver via a communications network.

4. The method of claim 1, providing the virtual tuner to the content receiver includes recording the selected content and providing the recorded content to the content receiver.

5. A method in a terminal that communicates over a communications network, the method comprising:
browsing content at the terminal;
searching for content associated with the browsed content;
scheduling content associated with the browsed content at a content receiver entity other than the terminal;
requesting that a content provider provide a virtual tuner to the content receiver entity in the event of a scheduling conflict at the content receiver entity.

6. The method of claim 5, searching for content associated with the browsed content includes searching an electronic program guide for content.

7. The method of claim 5, accepting a condition that must be satisfied before the virtual tuner is provided to the content receiver entity.

8. The method of claim 5, providing an indication that a condition has been satisfied before the virtual tuner is provided to the content receiver entity.

9. The method of claim 5,
viewing promotional content at the terminal,
providing an indication that the promotional contents reviewed before the virtual tuner is provided to the content receiver entity.

10. The method of claim 1, the content provider providing the virtual tuner to the content receiver conditionally, wherein the condition requires subscriber to view additional content during content selection, scheduling, or viewing.

11. A method for scheduling reception of content in a content receiver client having a tuner resource, the method comprising:
scheduling reception of selected content by the tuner resource at a particular time;
in response to scheduling, providing an indication that the selected content may be available from a content provider at an alternative time in the event that the tuner resource is not available to receive the selected content when scheduled.

12. The method of claim 11, providing an indication includes indicating that the content provider will provide a virtual tuner in the event that the tuner resource is not available to receive the selected content when scheduled.

13. The method of claim 11,
scheduling the scheduling reception of the selected content from an interactive user interface,
providing the indication that the selected content may be available from a content provider at an alternative time on the interactive user interface.

14. The method of claim 11, receiving the selected content from the content provider at the alternative time.

15. The method of claim 11, receiving non-selected content from the content server at the content receiver client before the selected content is made available to the content receiver client.

16. The method of claim 11, communicating an indication that a condition has been satisfied before receiving the selected content.

17. The method of claim 11, indicating that the tuner resource is not available to receive the selected content at the particular time.

18. The method of claim 11, scheduling the reception of the selected content by the tuner resource from a remote device that communicates with the content receiver client via an intermediate network.
